(19) United States
(12) Patent Application Publication
(10) Pub. No.: US 2024/0247588 A1
(43) Pub. Date: Jul. 25, 2024

(54) METHOD OF MINING A ROCK FORMATION USING A DISC CUTTER AND A ROCK BREAKER TOOL

(71) Applicant: Element Six (UK) Limited, Oxfordshire (GB)

(72) Inventors: Shuo LU, Oxfordshire (GB); Habib SARIDIKMEN, Oxfordshire (GB)

(21) Appl. No.: 18/560,823

(22) PCT Filed: May 19, 2022
(86) PCT No.: PCT/EP2022/063520

§ 371 Date: Nov. 14, 2023

(30) Foreign Application Priority Data
May 19, 2021 (GB) 2107150.1

(51) Int. Cl. E21C 27/14; E21C 27/12

(52) U.S. Cl. CPC E21C 27/14; E21C 27/128

(57) ABSTRACT

This disclosure relates to a method of mining a rock formation using a disc cutter and a rock breaker tool. Several examples of rock breaker tool are provided, including mini disc cutters and a form of hydraulic striker. The tool is inserted into slits cut into the rock by the disc cutter and activated, causing crack initiation and propagation in the rock.

### FIELD OF THE INVENTION

The present disclosure relates to a rotatable disc cutter for use in an excavation machine finding utility in mining, construction, trenching, and tunnel boring applications. In particular, it relates to a disc cutter comprising superhard cutting elements mounted in tool holders around a peripheral edge of the disc cutter.

### BACKGROUND

WO 2019/180164 A1, WO 2019/180169 A1 and WO 2019/180170 A1 each disclose a cutting assembly for use in above and below ground quarries and mines. The cutting assembly is typically used to extract slabs of rock from the ground, before the slabs are taken for further processing, such as polishing.

Each cutting assembly comprises a circular disc cutter, which is moveable between horizontal and vertical cutting orientations. Referring initially to FIGS. 1 and 2, a cutting assembly for slicing into natural formations 2 underground is indicated generally at 10. The cutting assembly forms part of a long wall mining system 1, commonly found in underground mines. The cutting assembly is a substitute for known shearer technology, which operates on a mine floor 4, amidst a series of adjustable roof supports 6. As the shearer advances in the direction of mining, the roof supports 6 are positioned to uphold the mine roof 8 directly behind the shearer. Behind the roof supports 6, the mine roof 6 collapses in a relatively controlled manner. Typically, a gathering arm collects mined rock at the cutting face and transfers it onto a conveying system for subsequent removal from the mine.

As indicated in FIGS. 1 and 2, the cutting assembly 10 comprises a base unit 12, a pair of spaced apart support arms 14 extending from the base unit 12, a drive spindle 16 extending between and rotatably mounted to the pair of moveable support arms 14, and a plurality of disc cutters 18 fixed about the drive spindle 16.

In a second example, indicated in FIGS. 3 and 4, a single support arm 14 extends from the base unit 12. The drive spindle 16 is supported centrally by the single support arm 14, and the plurality of disc cutters 18 is mounted to the drive spindle 16, distributed either side of the single support arm 14.

The base unit 12 functions as a transport system for the disc cutter 18. The base unit 12 is moveable to advance and retract the disc cutter 18 into and out of an operational position, in close proximity to the rock formation 2 to be cut. The speed at which the base unit 12 moves closer to the rock formation 2 is one of several variables determining the feed rate of the cutting assembly 10 into the rock formation 2. The base unit 12 (in concert with the roof supports 6) is also moveable sideways, from left to right and vice versa, along the long wall of the rock formation 2 to be mined.

Each support arm 14 is configured to be moveable into a first and a second cutting orientation. In the first cutting orientation, best seen in FIGS. 1 and 2, the drive spindle 16 is horizontal. As a result, cuts in the rock formation 2 made by the disc cutter 18 are correspondingly vertical. In the second cutting orientation, best seen in FIGS. 3 and 4, the drive spindle 16 is vertical. Consequently, cuts in the rock formation 2 made by the disc cutter 18 are correspondingly horizontal.

Each support arm 14 is moveable between a first operative position and a second operative position, in optionally each of the first and second cutting orientations, according to the depth of cut required. This is indicated by double end arrow A in FIG. 2. For example, in the first operative position, the drive spindle 16 is lowered so as to be in close proximity to the mine floor 4 and in the second operative position, the drive spindle 16 is raised so as to be in close proximity to the mine roof 8.

In use, the disc cutter 18 is brought into contact with the rock formation 2 and rotation of the drive spindle 16, and therefore its disc cutter(s) 18, causes slicing of the rock formation 2. The cutting assembly 10 slices into the rock formation 2, for example, to create clean orthogonal cuts, the size of which depends on the size of the cutting elements 22 selected. The cut rock breakouts either under its own weight or with secondary wedge force, e.g. using a wedge-shaped tool.

A problem with the assemblies described above is that cut rock breaking out under its own weight can be difficult to control and are often unpredictable. This applies even when using a secondary wedge force, e.g. using a wedge-shaped tool.

It is an object of the invention to provide a cutting system which makes the liberation of cut rock more predictable, with cleaner lines and quicker retrieval.

### SUMMARY OF THE INVENTION

In a first aspect of the invention, there is provided a method of mining a rock formation using a cutting system comprising a cutting assembly and a rock breaker tool, the method comprising:
providing a cutting assembly comprising a plurality of disc cutters arranged spaced apart on a spindle;
providing a rock breaker tool with a tool head;
advancing the cutting assembly into an operational position;
cutting into the rock formation using the disc cutters to create a series of linear cuts spaced apart by rock pillars;
retreating the cutting assembly from the operational position;
inserting the rock breaker tool into one of the cuts created by the disc cutters such that the tool head is fully positioned within the cut;
activating the rock breaker tool, thereby triggering the tool head to make contact with at least one adjacent rock pillar.

Optional and/or preferable features of the first aspect of the invention are provided in claims 2 to 7.

In a second aspect of the invention, there is provided a rock breaker tool for use in the method of the first aspect of the invention, the rock breaker tool comprising an elongate tool body and a tool head at one end thereof, the rock breaker tool having a longitudinal axis.

Optional and/or preferable features of the second aspect of the invention are provided in claims 9 to 13.

In a third aspect of the invention, there is provided a rock breaker tool for use in the method of the first aspect of the invention, the rock breaker tool comprising a tool head, the tool head comprising an elongate disc carrier, a base mount, and one or more mini disc cutters supported by the disc carrier, the disc carrier being moveable relative to the base mount.

Optional and/or preferable features of the third aspect of the invention are provided in claims 15 to 18.

In a fourth aspect of the invention, there is provided a cutting system comprising a disc cutter and a rock breaker tool in accordance with the second and third aspects.

Optional and/or preferable features of the fourth aspect of the invention are provided in claim 19.

### BRIEF DESCRIPTION OF THE DRAWINGS

The invention will now be more particularly described, by way of example only, with reference to the accompanying drawings, in which

FIG. 1 is a schematic plan view of an underground mine incorporating an example of a prior art cutting assembly as part of a long wall mining system, and in particular shows the cutting assembly in a horizontal orientation;

FIG. 2 is a schematic end view of the long wall mining system of FIG. 1;

FIG. 3 is a schematic plan view of an underground mine incorporating a further example of a prior art cutting assembly as part of a long wall mining system, and in particular shows the cutting assembly in a vertical orientation;

FIG. 4 is schematic end view of the long wall mining system of FIG. 3;

FIG. 5 is a perspective view of an example disc cutter;

FIG. 6 is a side view of a cutter body forming part of the disc cutter of FIG. 5;

FIG. 7 is a front view of a set of tool holders and cutting elements forming part of the disc cutter of FIG. 5;

FIG. 8 is an exploded partial view of the disc cutter of FIG. 5;

FIG. 9 is a top view of the disc cutter of FIG. 5;

FIG. 10 is another top view of the disc cutter of FIG. 5;

FIG. 11 is a schematic front view showing the effective combined cutting face provided by the cutting elements of FIG. 5;

FIG. 12 is a partial view of one embodiment of a disc cutter in accordance with the invention;

FIG. 13 is a partial perspective view of another embodiment of a disc cutter in accordance with the invention;

FIG. 14 is a schematic perspective view showing the equivalent combined cutting face provided by the cutting elements of FIG. 13;

FIG. 15 is a schematic front view showing the effective combined cutting face provided by the cutting elements of FIG. 13;

FIG. 16 is a plan view of an embodiment of a tool holder for use in the disc cutter of FIG. 12 or 13;

FIG. 17 is a schematic flow diagram showing one method of using the cutting assembly in accordance with the invention;

FIG. 18 is a plan view of an embodiment of a rock breaker tool;

FIG. 19 is a perspective view of the rock breaker tool of FIG. 18 in use in a mine environment;

FIG. 20 is a perspective view of another embodiment of a rock breaker tool;

FIG. 21 is a perspective view of the rock breaker tool of FIG. 20 in use in a mine environment; and

FIG. 22 is a schematic plan view of another embodiment of a rock breaker tool in use in a mine environment.

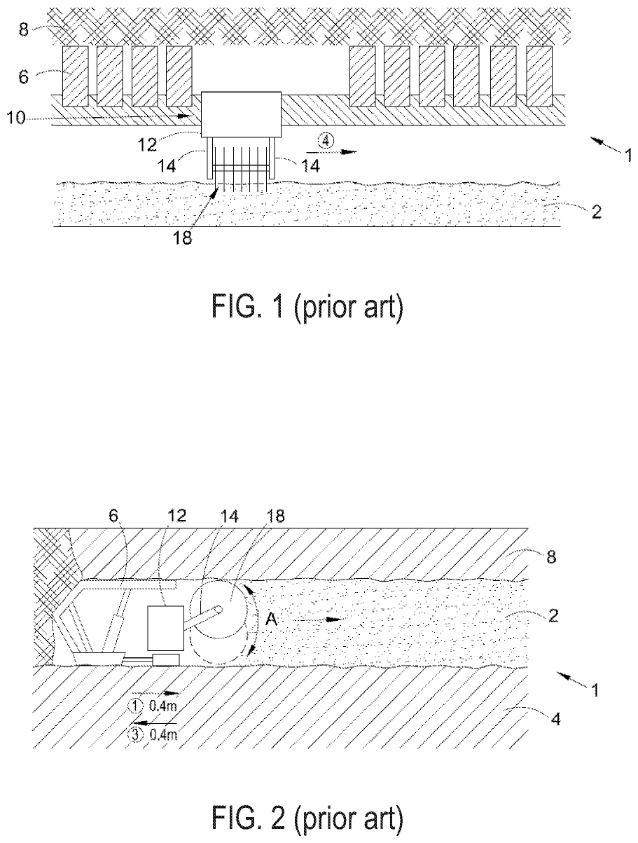

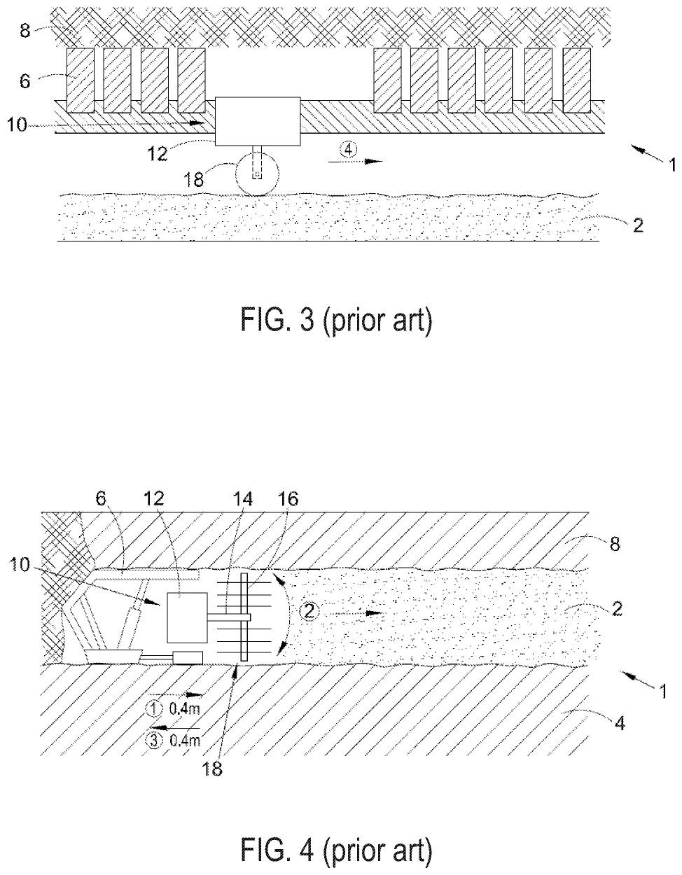

In the drawings, similar parts have been assigned similar reference numerals.

### DETAILED DESCRIPTION

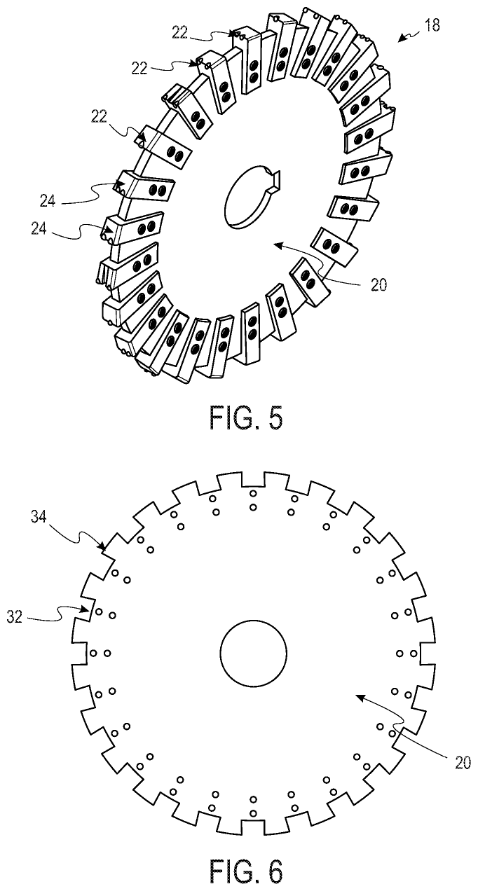

FIG. 5 shows an example of a disc cutter 18, which comprises a generally circular body 20 and a plurality of cutting elements 22 arranged peripherally around the circular body 20. Rotation of the drive spindle 16 causes a corresponding rotation of the disc cutter 18.

The disc cutter 18 comprises a plurality of tool holders 24 for each receiving at least one cutting element 22. In this example, there is a repeating set of four tool holders 24 and seven cutting elements 22. There are forty-two cutting elements 22 in total. Each set is repeated identically about the circular body 20. In each set, there are four different spatial configurations of tool holder 24 and cutting element 22, as explained in more detail below. When arranged in sequence, one behind the other in the direction of rotation of the disc cutter 18, the required cutting force of the disc cutter 18 is significantly reduced.

Each tool holder 24 comprises a body portion 26 and a pair of spaced apart legs 28 extending from the body portion 26. The body portion 26 is generally cuboidal. The body portion 26 hosts the or each cutting element 22. Each leg 28 of the pair of legs is plate-like. The legs 28 are spaced apart by a gap 30, which enables coupling of the tool holder 24 either side of the circular body 20. A plurality of slots 32 are positioned periodically along the circumferential surface 34 of the generally circular body 20, as shown in FIG. 6. Each slot 32 becomes occupied with said gap 30 when the tool holder 24 is mounted on the circular body 20. The slots 32 reduce the shear force on the bolts during use. By virtue of the circumferential surface 34 of the circular body 20 extending between neighbouring slots 32, tool holders 24 are regularly spaced apart around the circular body 20. In this example, twenty-four slots are provided for twenty-four tool holders 24.

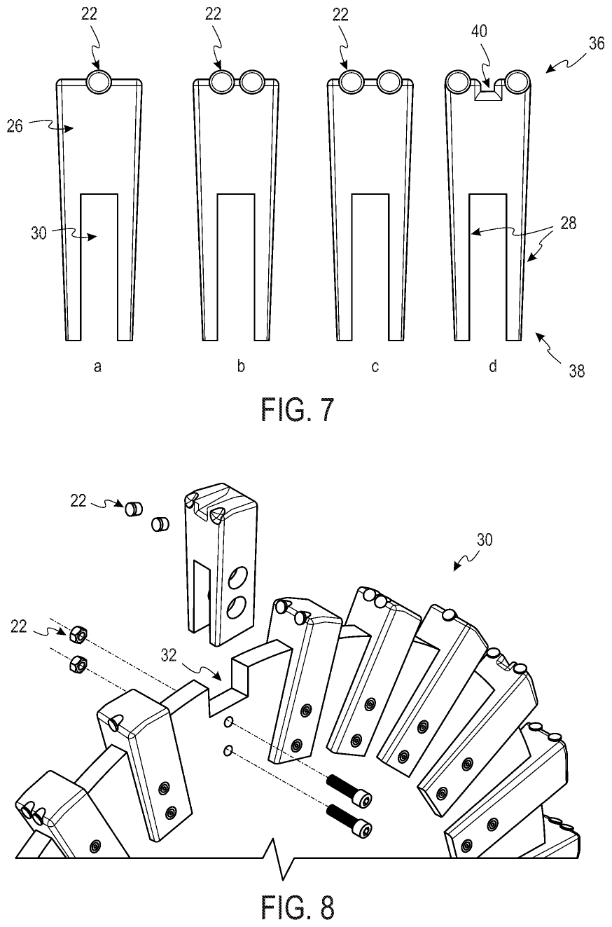

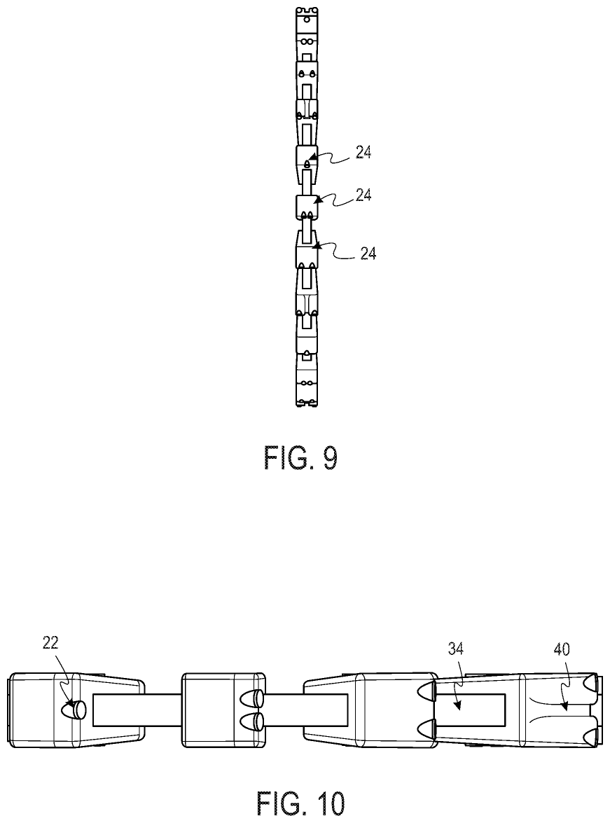

Turning now to FIG. 7, the tool holder 24 tapers inwardly from a first end 36, proximate the or each cutting element 22, towards a second end 38, proximate a free end of each leg 28.

A first variant of the tool holder 24 is shown in FIG. 7a, which is configured to seat a single, (axially) centrally mounted, cutting element 22.

A second variant of the tool holder is shown in FIG. 7b, which is configured to seat two adjacent cutting elements 22.

A third variant of the tool holder 24 is shown in FIG. 7c, which is configured to seat two spaced apart cutting elements 22.

A fourth variant of the tool holder 24 is shown in FIG. 7d, which is configured to seat two spaced apart cutting elements 22 with a central recessed channel 40 between the two cutting elements 22. The elongate channel 36 extends in the direction of intended rotation of the disc cutter 18—see FIG. 10.

Preferably, the tool holders are arranged in the following sequence: d), c), b), a) as shown in FIG. 8. However, any ordering within the sequence is envisaged provided that all four tool holder configurations are used. For example, see Table 1.

TABLE 1

Position within sequence

| | First | Second | Third | Fourth |
|---|---|---|---|---|
| Tool holder | a | b | c | d |
| configuration | a | b | d | c |
| | a | c | b | d |
| | a | c | d | b |
| | a | d | b | c |

It is also feasible to use sets containing two, three or more configurations of tool holder(s) and cutting element(s). The size of each cutting element 22 and the spacing between the cutting elements, if more than one cutting element is used on a particular tool holder 24, will need to be adjusted accordingly.

The cutting elements 22 in each set produce an overlapping cut, indicated generally at 42, in the rock, as shown in FIG. 11. This evenly distributes the cutting force on the cutting slot. The overlapping cut in the main embodiment is 60 mm, and this is based on four tool holder and cutting element combinations within each set. If a larger overlapping cut is required, more tool holder and cutting element combinations would be used, for example, six, eight, ten, twelve etc. If a smaller overlapping cut is required, less tool holder and cutting element combinations would be required, for example two or three.

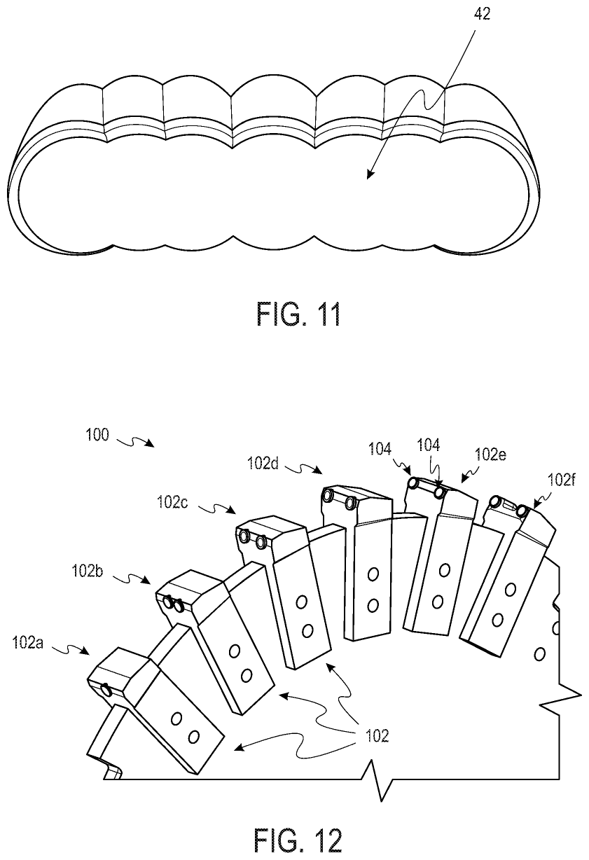

FIG. 12 shows a first example of a disc cutter at 100 for use with the invention. The disc cutter 100 comprises a set of six tool holders 102. Cutting elements 104 mounted on the tool holders 102 are arranged in a pre-determined sequence. The total quantity of cutting elements 104 in each set is eleven. Multiple sets are mounted about the disc body. The quantity and spacing of the cutting elements depends on the position of the tool holder 102 in the set. The tool holder in first position, designated 102a leads the set. The tool holder in second position is designated 102b. The tool holder in third position is designated 102c. The tool holder in fourth position is designated 102d. The tool holder in fifth position is designated 102e. The tool holder in sixth position, designated 102f, trails the set.

The tool holders 102 are similar to those described earlier with respect to FIG. 7. As before, there is a single cutting element on the tool holder 102a in first position. There are two adjacent cutting elements on the tool holder 102b in second position. There are two spaced apart cutting elements on the tool holder 102c in third position. In the last position of the sequence 102f, there are two spaced apart cutting elements on the tool holder, and a recessed channel extends between the two cutting elements. However, the set additionally contains two modified versions of tool holder c. In tool holder c′, the spacing between cutting elements is greater than in tool holder c. In tool holder c″, the spacing between cutting elements is greater than in tool holder c′.

The sequence is summarised in Table 2.

TABLE 2

| | Position within sequence | | | | | |
|---|---|---|---|---|---|---|
| | First | Second | Third | Fourth | Fifth | Sixth |
| Tool holder configuration | a | b | c | c′ | c″ | d |

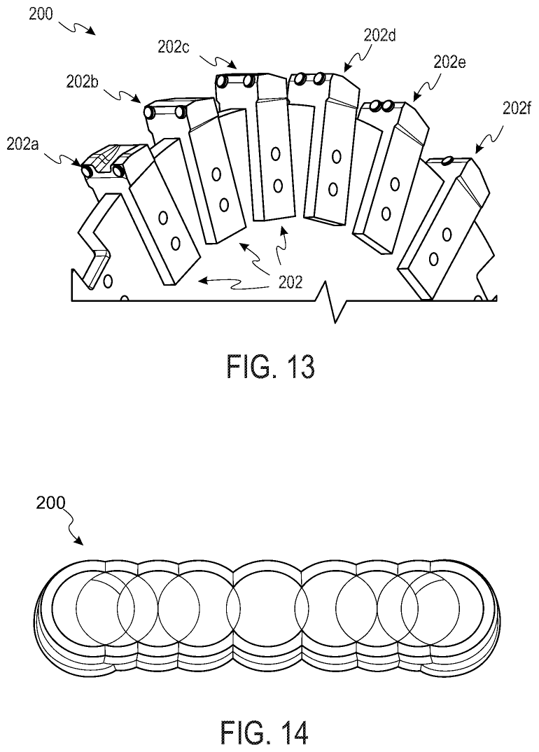

FIG. 13 shows a second example of a disc cutter 200 for use with the invention. The disc cutter 200 comprises a set of six tool holders 202. Cutting elements 204 mounted on the tool holders 202 are again arranged in a pre-determined sequence. The total quantity of cutting elements 204 in each set is eleven. Multiple sets are mounted about the disc body. The quantity and spacing of the cutting elements 204 on each tool holder 202 depends on the position of the tool holder 202 in the set. The tool holder in first position, designated 202a leads the set. The tool holder in second position is designated 202b. The tool holder in third position is designated 202c. The tool holder in fourth position is designated 202d. The tool holder in fifth position is designated 202e. The tool holder in sixth position, designated 202f, trails the set.

In this embodiment, the tool holder 202a in the first position comprises two spaced apart cutting elements. A recessed channel extends between them. The channel slopes upwardly between a leading and a trailing edge of the tool holder 202a. Tests have proved that the material between two cutting elements will gradually wear away in use. Thus, the corresponding torque and power will be higher. By removing the material between the cutting elements removed prior to first use, the unnecessary initial load is reduced and cutting occurs more smoothly. The tool holder 202b in the second position comprises two spaced apart cutting elements. There is no recessed channel extending between them. The tool holder 202c in the third position comprises two spaced apart cutting elements. These cutting elements are slightly closer together than the cutting elements on the tool holder in the second position. The tool holder 202d in the fourth position comprises two spaced apart cutting elements. These cutting elements are slightly closer together than the cutting elements on the tool holder in the third position. The tool holder 202e in the fifth position comprises two adjacent cutting elements. The tool holder 202f in the sixth position comprises a single cutting element.

The sequence is summarised in Table 3 and it is the preferred sequence.

TABLE 3

| | Position within sequence | | | | | |
|---|---|---|---|---|---|---|
| | First | Second | Third | Fourth | Fifth | Sixth |
| Tool holder configuration | d | c″ | c′ | c | b | a |

In brief, the sequence is a reverse of the one shown in Table 2.

Possible alternative sequences are provided in Table 4.

TABLE 4

| | Position within sequence | | | | | |
|---|---|---|---|---|---|---|
| | First | Second | Third | Fourth | Fifth | Sixth |
| Tool holder configuration | d | c′ | c′ | c | b | a |
| | b | a | d | c″ | c′ | c |
| | c | b | a | d | c″ | c′ |
| | c′ | c | b | a | d | c″ |
| | c″ | c′ | c | b | a | d |

However, any ordering within the sequence is envisaged provided that all six tool holder configurations are used.

The cutting elements are preferably polycrystalline diamond compacts (PDCs), commonly found in the Oil and Gas industry on drill bits. Each cutting element 204 is cylindrical with a planar working surface that comprises polycrystalline diamond. The working surface of each cutting element 204 are all aligned in the same direction. The cutting elements 204 all face tangentially in the direction of rotation—see FIG. 13). Additionally, the cutting elements 204 all face in a plane parallel and in line with the disc body, as shown in FIG. 16, in which the angle between the plane of the disc body and the direction of the working face is 0 degrees.

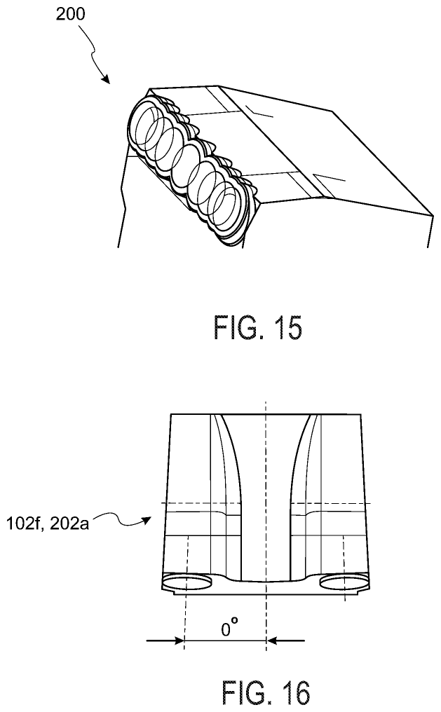

As the disc cutter 200 rotates, the first tool holder 202a is presented to the rock formation, then the second tool holder 202b, then the third tool holder 202c and so on. The cutting elements 204 supported by the tool holders 202 sequentially cut into the rock formation. The effect of the pre-configured sequence of cutting elements 204 results in the effective cutting pattern shown in FIG. 14. This effect could feasibly be achieved by using a single equivalent tool holder and a multitude of cutting elements in a side-by-side arrangement, similar to FIG. 15. However, the forces required during cutting to achieve the same effective cutting (i.e. slot) width would be prohibitively high. Instead, by spreading the cutting forces over six sequential tool holders 202, the forces on each tool holder during cutting are significantly reduced, minimising cutting element 204 breakages.

A similar effect may be achieved using the first example of the disk cutter. However, trials have shown that cutting is smoother and less prone to vibrations using the disk cutter in the second example.

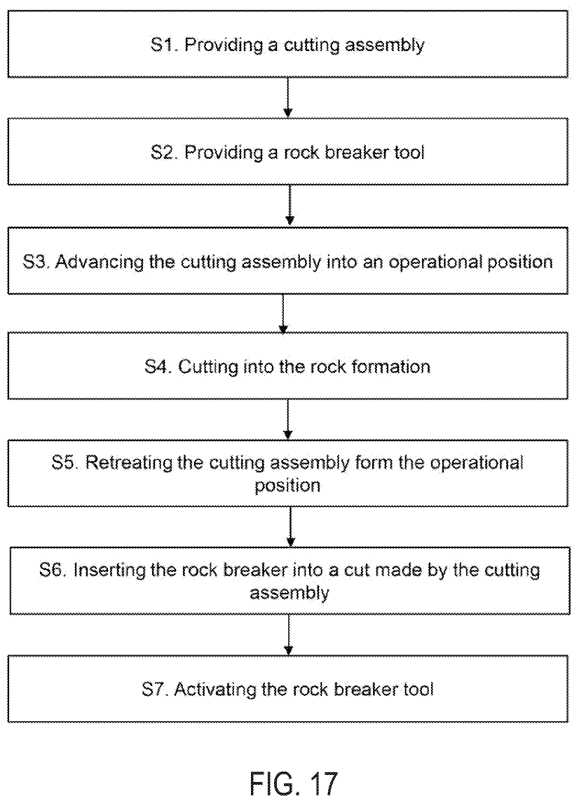

FIG. 17 shows one way in which the cutting assembly may be put to use in practice. FIG. 17 is a flow diagram showing method steps, in which the following numbering corresponds to that of FIG. 17.
S1. A cutting assembly is provided, in which the cutting assembly comprises a plurality of disc cutters arranged spaced apart on a spindle. As described previously, each disc cutter preferably comprise a cutter body having an axis of rotation, a plurality of tool holders and a plurality of cutting elements. The tool holders and cutting elements are arranged in at least one set about the cutter body, each set comprising six tool holders arranged in first, second, third, fourth, fifth and sixth positions. The positions are in sequential order one behind the other in the direction of rotation. Each tool holder supports one or more of the plurality of cutting elements, the cutting elements being provided in a pre-determined sequence of configurations from first position to sixth position. In the pre-determined sequence of configurations, the quantity of cutting elements and/or the lateral spacing of the cutting elements varies.
S2. A rock breaker tool with a tool head is provided. More information is provided on the rock breaker tools below.
S3. The cutting assembly is advanced into an operational position. The operational position is expected to be the location where cutting takes place, for example in front of the rock formation to be cut. Advancement may mean the entire cutting assembly is moved into position or simply the components required for cutting, e.g. disc cutters.
S4. Disc cutters in the cutting assembly cut into the rock formation using the disc cutters to create a series of linear cuts 250a, 250b, 250c (and so on) spaced apart by rock pillars 252a, 252b, 252c (and so on). Example schematics of the linear cuts and rock pillars can be seen in FIGS. 19 and 21.
S5. The cutting assembly is retreated from the operational position.
S6. The rock breaker tool is inserted into one of the cuts created by the disc cutters such that the tool head is fully positioned within the cut.
S7. The rock breaker tool is activated, thereby triggering the tool head to make contact with at least one adjacent rock pillar.

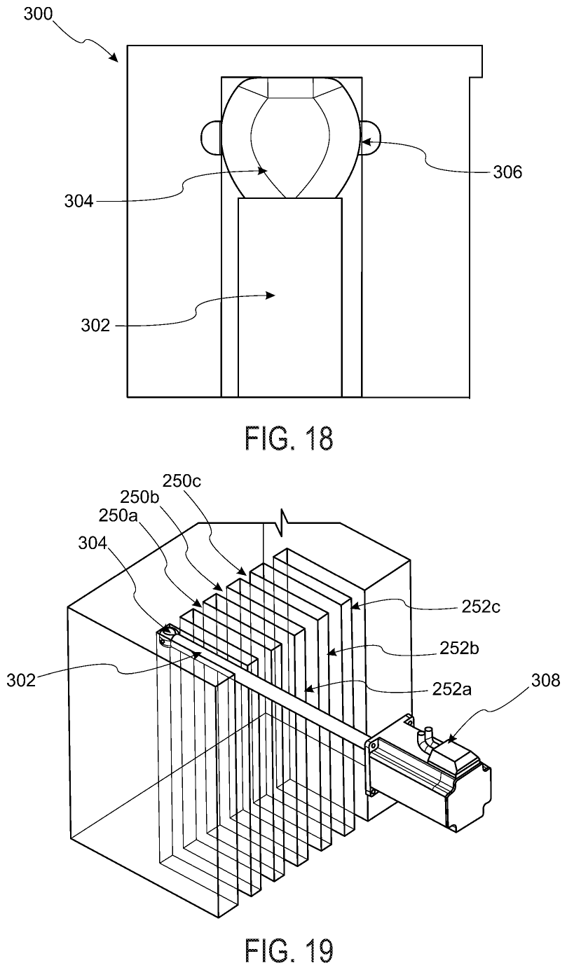

In the embodiment shown in FIGS. 18 and 19, the rock breaker tool 300 comprises an elongate tool body 302 having a longitudinal axis, and a tool head 304 at one end of the tool body 302. The tool head 304 comprises one or more projections 306 extending from a surface thereof. Activating the rock breaker tool 300 comprises slowly rotating the rock breaker tool about the longitudinal axis, from an insertion orientation to a rock breaking orientation. In this manner, the tool head 304, or more specifically the projection(s) 306, thereby impinges on at least one adjacent rock pillar. Preferably, this takes place at the root of the linear cut, in the cutting slot. This impingement can be sufficient to generate cracks in the rock formation, which facilitates subsequent retrieval of the broken rock formation. This slow rotation rock breaking advantageously uses the least energy to break the rock from the root of the cutting slot. Optionally, the tool head 304 is configured to impinge on two adjacent rock pillars.

For example, with a 30 KW motor enabling the rock breaker tool to rotate, if the rotational speed is 60 rpm, the torque can be 4774 Nm. When the radius of extrusion is 34 mm, the cutting force can be 14 kN.

Optionally, the rock breaker tool 300 further comprises a handle (not shown) at the opposite end to the tool head 304. Alternatively, the rock breaker tool 300 further comprises an attachment unit 308 at the opposite end for attachment with the cutting assembly.

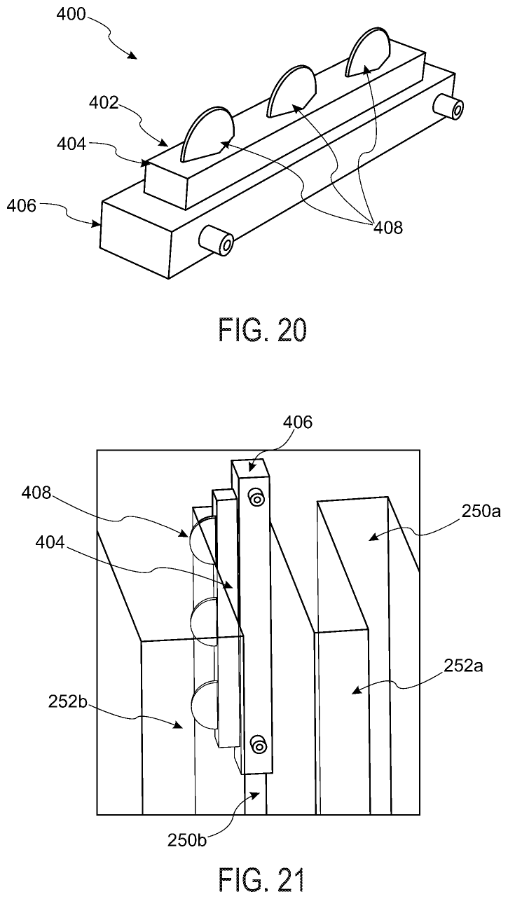

In the embodiment shown in FIGS. 20 and 21, the rock breaker tool 400 comprises a tool head 402, in which the tool head 402 comprising an elongate disc carrier 404, a base mount 406, and one or more mini disc cutters 408 supported by the disc carrier 404. The disc carrier 404, and therefore the mini disc cutters 408 too, is moveable relative to the base mount 406. Preferably, the tool head 400 comprises three or more mini disc cutters 408 spaced out along the disc mount 406. The mini disc cutters 408 preferably comprise carbide material. Distinct from the disc cutters of the main cutting assembly, the mini disc cutters in this embodiment have a compressed pyramidal shape with a circular base and low height.

Each mini disc cutter 408 may extend in a plane that is orthogonal to the longitudinal plane of the disc mount 406. Alternatively, each mini disc cutter 408 may extend in a plane that forms an angle with respect to the longitudinal plane of the disc mount 406, the rock breaker tool 400 being configured such that said angle is adjustable. Activating the rock breaker tool 400 comprises cutting into the rock pillar using the mini disc cutters 408 on the tool head 402. In this way, cracks in the rock pillar may be initiated at multiple locations, which facilitates subsequent retrieval of the broken rock formation. This rock breaking method advantageously uses the least energy to break the rock along a predetermined direction.

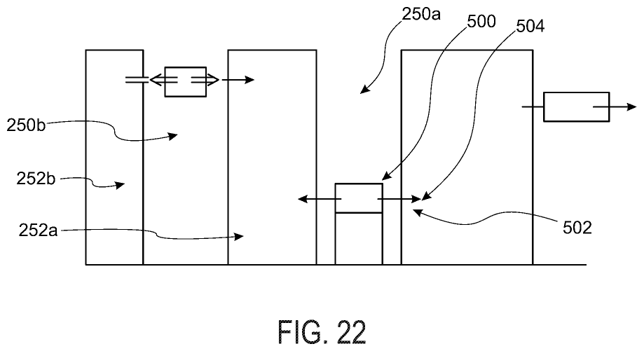

In the embodiment indicated in FIG. 22, the tool head 500 comprises one or more strike elements 502 actuatable to extend outwardly and to retract inwardly. The actuators may be hydraulic expanders. The strike elements 502 may comprise a superhard strike tip 504. Activating the rock breaker tool 500 comprises firing the strike elements 502 from the tool head 500 towards the adjacent rock pillar. Impact from the strike tips can be sufficient to generate cracks and subsequent crack propagation. Again, this facilitates subsequent retrieval of the broken rock formation. Optionally, two opposing strike elements 502 are fired towards adjacent rock pillars on either side of the linear cut.

Optionally and as seen in FIG. 22, multiple tool heads may be deployed to actuate in positions at multiple depths within the cut to force fracture of the rock pillars.

While this invention has been particularly shown and described with reference to embodiments, it will be understood by those skilled in the art that various changes in form and detail may be made without departing from the scope of the invention as defined by the appended claims.

1. A method of mining a rock formation using a cutting system comprising a cutting assembly and a rock breaker tool, the method comprising:
providing a cutting assembly comprising a plurality of disc cutters arranged spaced apart on a spindle;
providing a rock breaker tool with a tool head;
advancing the cutting assembly into an operational position;
cutting into the rock formation using the disc cutters to create a series of linear cuts spaced apart by rock pillars;
retreating the cutting assembly from the operational position;
inserting the rock breaker tool into one of the cuts created by the disc cutters such that the tool head is fully positioned within the cut;
activating the rock breaker tool, thereby triggering the tool head to make contact with at least one adjacent rock pillar.

2. A method as claimed in claim 1, wherein activating the rock breaker tool comprises rotating the rock breaker tool about a longitudinal axis thereof, from an insertion orientation to a rock breaking orientation, the tool head thereby impinging on at least one adjacent rock pillar.

3. A method as claimed in claim 2, comprising impinging the tool head on two adjacent rock pillars.

4. A method as claimed in claim 1, wherein activating the rock breaker tool comprises cutting into the rock pillar using one or more mini disc cutters on the tool head.

5. A method as claimed in claim 4, using a plurality of mini disc cutters to cut into the rock pillar at multiple locations.

6. A method as claimed in claim 1, wherein activating the rock breaker tool comprises firing one or more strike elements from the tool head towards the adjacent rock pillar.

7. A method as claimed in claim 6, comprising firing two opposing strike elements towards adjacent rock pillars on either side of the cut.

8. A rock breaker tool for use in the method of claim 1, the rock breaker tool comprising an elongate tool body and a tool head at one end thereof, the rock breaker tool having a longitudinal axis.

9. A rock breaker tool as claimed in claim 8, wherein the tool head comprises one or more projections extending from a surface thereof.

10. A rock breaker tool as claimed in claim 9, further comprising a handle at an opposing end to the tool head.

11. A rock breaker tool as claimed in claim 9, further comprising an attachment unit at an opposing end to the tool head for attachment with a cutting assembly.

12. A rock breaker tool as claimed in claim 8, wherein the tool head comprises one or more strike elements actuatable to extend outwardly and to retract inwardly.

13. A rock breaker tool as claimed in claim 12, wherein the strike elements comprise a superhard strike tip.

14. A rock breaker tool for use in the method of claim 1, the rock breaker tool comprising a tool head, the tool head comprising an elongate disc carrier, a base mount, and one or more mini disc cutters supported by the disc carrier, the disc carrier being moveable relative to the base mount.

15. A rock breaker tool as claimed in claim 14, comprising three or more mini disc cutters spaced out along the disc mount.

16. A rock breaker tool as claimed in claim 14, wherein the mini disc cutters comprise carbide material.

17. A rock breaker tool as claimed in claim 14, wherein each mini disc cutter extends in a plane that is orthogonal to the longitudinal plane of the disc mount.

18. A rock breaker tool as claimed in claim 14, wherein each mini disc cutter extends in a plane that forms an angle with respect to the longitudinal plane of the disc mount, the rock breaker tool being configured such that said angle is adjustable.

19. A cutting system comprising a disc cutter and a rock breaker tool as claimed in claim 8.

20. A cutting system as claimed in claim 19, wherein the disc cutter comprises a cutter body having an axis of rotation, a plurality of tool holders and a plurality of cutting elements, the tool holders and cutting elements arranged in at least one set about the cutter body, each set comprising six tool holders arranged in first, second, third, fourth, fifth and sixth positions, said positions being in sequential order one behind the other in the direction of rotation, each tool holder supporting one or more of the plurality of cutting elements, the cutting elements being provided in a pre-determined sequence of configurations from first position to sixth position, wherein in the pre-determined sequence of configurations the quantity of cutting elements and/or the lateral spacing of the cutting elements varies.
